(19) United States
(12) Patent Application Publication
(10) Pub. No.: US 2011/0185047 A1
(43) Pub. Date: Jul. 28, 2011

(54) SYSTEM AND METHOD FOR A DISTRIBUTED FAULT TOLERANT NETWORK CONFIGURATION REPOSITORY

(75) Inventors: Ravichander Vaidyanathan, Belle Mead, NJ (US); Yuu-Heng Cheng, Piscataway, NJ (US); Stuart Wagner, Milford, NJ (US)

(73) Assignee: TELCORDIA TECHNOLOGIES, INC., Piscataway, NJ (US)

(21) Appl. No.: 12/694,560

(22) Filed: Jan. 27, 2010

(51) Int. Cl. G06F 15/177; G06F 15/173

(52) U.S. Cl. 709/220; 709/223

(57) ABSTRACT

An autonomous management cluster of network elements serves as a distributed configuration repository. Network elements sharing a common pre-determined shared identifier autonomously form themselves as a management cluster. The network elements in the cluster exchange configuration files. In the event of a loss, destruction, or corruption of one of the network element's configuration file, the network element recovers its configuration file from its closest neighbor in its management cluster. The management cluster can also be used to efficiently disseminate configuration changes by simply communicating the changes to one or more elements in the cluster, and allowing the other nodes in the cluster to discover and retrieve their updated configuration files.

### FIELD OF THE INVENTION

The present invention relates generally to the field of networking, and more particularly to methods and systems for a distributed, fault-tolerant network configuration repository.

### BACKGROUND

Network-centric tactical environments rely heavily on the timely dissemination of critical information related to sensors, situational awareness, command, and control to soldiers, planners, and other receivers in order to execute a successful mission. These environments use a communications network including hundreds of platforms, sensors, decision nodes, and computers communicating with each other to exchange information to support collaborative decision making in a real-time, dynamically changing, and critical situation.

Typically, these environments use a mobile ad hoc network consisting of wireless links to connect various types of devices. A mobile ad hoc network is a continuously evolving network as network elements dynamically join and leave. Mobile ad hoc networks are characterized by limited bandwidth and unreliable connectivity. For these reasons, typical network configuration methodologies are problematic for a mobile ad hoc network.

Network elements are configured to perform an assigned role with information such as IP addresses, routing protocols and parameters, quality of service policies, etc. This configuration information is often secured in a configuration file located on local disk drives or in removable storage. A network configuration repository may be used to store the configuration files of each network element as a backup in the case the configuration file is corrupted, lost, destroyed, etc.

Often, the network configuration repository is located in a central location (e.g., a server) in the network. However, in the case of a mobile ad hoc network, with limited bandwidth and intermittent network connectivity, it may not be practical to retrieve a configuration file from a central location that may be located several hops away in a timely manner. Accordingly, the characteristics of a mobile ad hoc network give rise to a need for a different management approach that can adapt to a dynamically changing network in a fault tolerant manner.

### SUMMARY

This Summary is provided to introduce a selection of concepts in a simplified form that are further described in the Detailed Description below. This Summary is not intended to identify essential features of the invention or claimed subject matter, nor is it intended to be used in determining the scope of the claimed subject matter.

The present invention pertains to network elements in a tactical environment that autonomously form a management cluster in order to serve as a distributed network configuration repository The network elements are pre-configured with a pre-determined shared identifier. When the network elements become operational within a network structure, the network elements engage in various communication exchanges to find other network elements having the same shared identifier and then form a management cluster. The configuration files of the network elements within the same management cluster are exchanged with all other network elements in the management cluster. In the event of a loss, corruption or destruction of one of the configuration files associated with a network element in the management cluster, the configuration file is recovered from the closest neighbor network element in the cluster. The management cluster may also be used as a distributed configuration repository to disseminate configuration changes by communicating the changes to one or more nodes within the management cluster. Other nodes within the management cluster can then retrieve their configuration changes by communicating locally within the cluster.

### BRIEF DESCRIPTION OF THE DRAWINGS

The subject matter disclosed is illustrated by way of example, and not by way of limitation, in the figures of the accompanying drawings in which the like reference numerals refer to similar elements and in which:

FIG. 1 is a schematic diagram of a network in accordance with an embodiment;

FIG. 2 is a schematic diagram of a self-formed management cluster in accordance with an embodiment;

FIG. 3 is a flow chart illustrating steps used to pre-configure and initialize a network element in accordance with an embodiment;

FIG. 4 is a flow chart illustrating steps used to autonomously form a management cluster in accordance with an embodiment; and

FIG. 5 is a flow chart illustrating steps used in configuration discovery in accordance with an embodiment.

### DETAILED DESCRIPTION

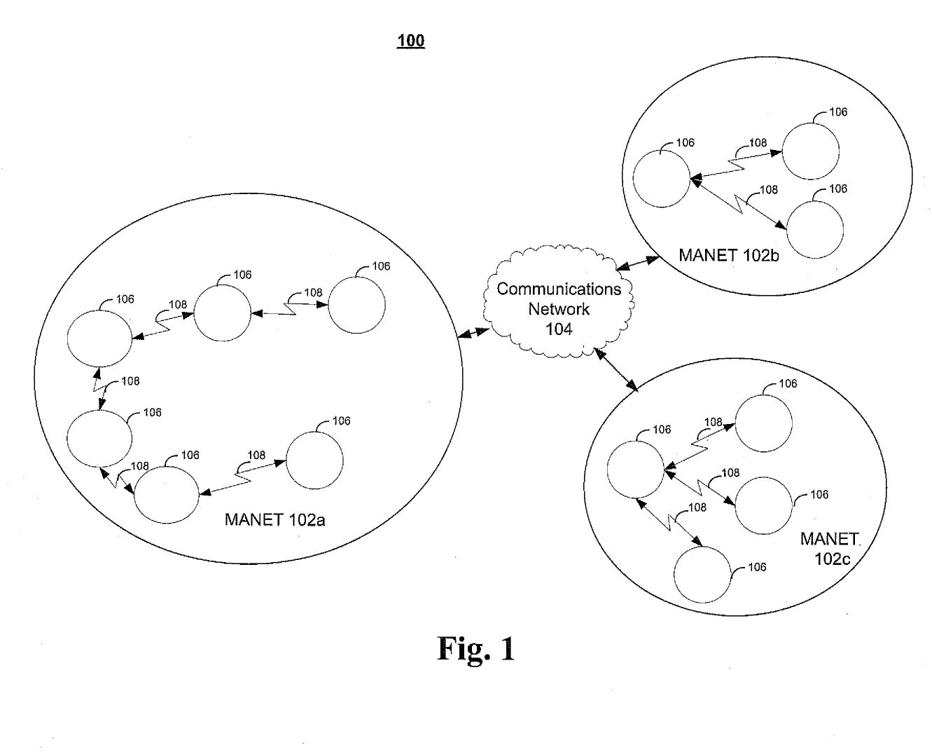

FIG. 1 shows an embodiment of a network-centric tactical environment 100. The tactical environment 100 can have several mobile ad hoc networks (MANETs) 102a-c connected via a communications network 104. Each mobile ad hoc network 102a-c has a number of nodes or network elements 106, connected through one or more communication links 108 that facilitate communication between the nodes 106. Each mobile ad hoc network 102a-c may be used by one or more military units for communicating data such as voice data, position telemetry, sensor data, and real-time video. Nodes 106 can be tactical radios, transmitters, satellites, receivers, workstations, computers, servers, wireless handheld devices, and/or other computing devices. For the purposes of this disclosure, the terms node and network elements are used interchangeably and denote devices associated with an IP address.

There may be various types of communication networks 104 within the tactical network 100 and each may be operating using a different communication protocol within a different network architecture. For instance, one communication network 104 may utilize an Ethernet local area network along with radio links to satellites and field units that operate at different throughputs and latencies. Tactical radios may communicate using both satellite communications and a direct radio frequency link. A high frequency network may be employed for long range transmissions. In addition, there are a number of routers, gateways, DNS servers, DHCP servers, and other networking components (not shown) that are part of the communications network 104 and are used to facilitate the transmission of data between the various mobile ad hoc networks 102a-c.

The communications links 108 used by nodes 106 in the mobile ad hoc networks 102a-c can be any wireless connection that facilitates communication between the mobile ad hoc networks, such as, without limitation, radio frequency, microwave, infrared, or cellular communication mediums.

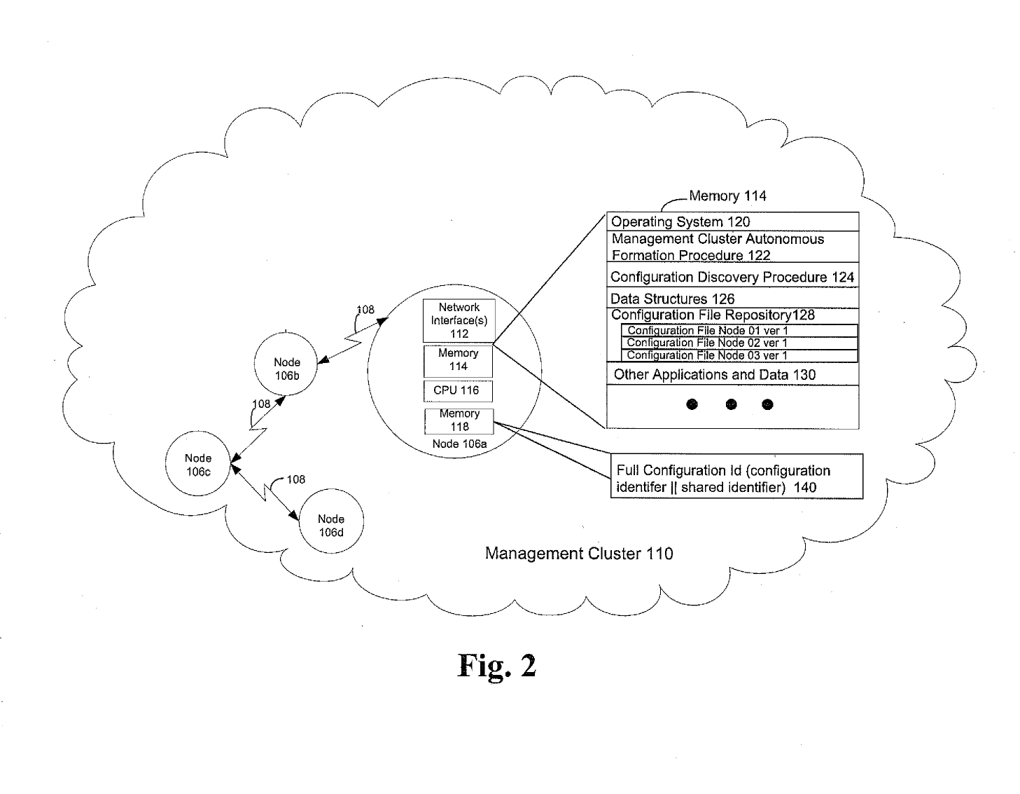

FIG. 2 depicts a management cluster 110. A management cluster 110 is a set of nodes 106a-d in a mobile ad hoc network that self-form based on a common identity. For example, in a tactical environment, a management cluster 110 can consist of mobile devices within the same battalion. Each node 106a-d in a management cluster 110 stores the network configuration files 128 of each of the other nodes 106a-d in the management cluster 110. In the event of a loss, destruction, or corruption of a node's configuration file 128, a node 106a-d can quickly retrieve its configuration file 128 through an exchange with a neighboring node in the same management cluster 110. In this manner, there is no dependence on a central repository that is located in a distant network, that may be several hops away, and the configuration file 128 can be replaced quickly.

Each node 106a-d in the management cluster 110 has, at a minimum, one or more network interfaces 112 for facilitating communication within and outside of the network, a first memory 114, a processor or CPU 116, and a second memory 118. The first memory 114 can be a computer readable medium that can store executable procedures, applications, and data. It can be any type of memory device (e.g., random access memory, read-only memory, etc.), magnetic storage, volatile storage, non-volatile storage, optical storage, DVD, CD, and the like. The first memory 114 can also include one or more external storage devices or remotely located storage devices. The first memory 114 can contain instructions and data as follows:
an operating system 120;
a management cluster autonomous formation procedure 122;
configuration discovery procedure 124;
various data structures used in these procedures 126;
a configuration file repository 128 that stores the configuration file of each node in the cluster and its associated version identifier; and
other applications and data 130.

In addition, there is a second memory 118 that can be a computer readable medium that can store executable procedures, applications, and data in a non-volatile memory, such as a read-only memory. The second memory 118 can be used to store the node's full configuration identifier 140. The full configuration identifier 140 consists of a configuration identifier that is unique to the node and a shared identifier. The shared identifier can be used to assimilate nodes into a common management cluster. Alternatively, there can be a single memory storage area that can be a computer readable medium formed of any type of memory device (e.g., random access memory, read-only memory, etc.), magnetic storage, volatile storage, non-volatile storage, optical storage, DVD, CD, and the like, that can be used to store the contents of memories 114 and 118 described above.

Attention now turns to a more detailed description of the network protocols.

The network-centric tactical environment 100 operates using the Internet Protocol in a preferred embodiment. Each mobile ad hoc network 102 can operate with a common routing protocol that is used to disseminate packets through the network. The routing protocol within the local network is often referred to as an interior gateway protocol (IGP) and the nodes within the local network are referred to as the IGP area. One such IGP routing protocol is the link state routing protocol, such as the open shortest path first (OSPF) protocol or the intermediate system to intermediate system (IS-IS) protocol. In the link state routing protocols, each router in the network maintains a map of the network topology indicating which nodes are connected to which other nodes. Each router determines the next best logical hop from one node to every other node in the network which forms the router's routing table. Whenever there is a change in the network topology, a link state advertisement (LSA) is distributed throughout the network notifying the other routers of the change. In response to the notification, each router modifies its routing table to reflect the change.

Each node in the network requires an IP address. The Dynamic Host Configuration Protocol (DHCP) is a network protocol that allows a DHCP server to assign an IP address to a node. Initially, when a node boots up, the node makes a request to the network for a DHCP server who responds with an appropriate IP address. The IP address is used to route packets between nodes in the network. A more detailed discussion of the DHCP can be found at RFC 3315, entitled “Dynamic Host Configuration Protocol for IPv6,” dated July 2003. Other mechanisms may also be used to obtain an IP address, such as manual configuration of an IP address by a network operator via a Command Line Interface (CLI). A CLI is a user interface that requires human intervention to type commands to perform functions or enter data.

Each node in the network is configured with the address of a Domain Name Server (DNS Server). A DNS server is a database that keeps track of each domain name and its associated IP address. The address of the DNS sewer may be learned by the node during the IP address acquisition process (for instance, via the DHCP protocol) or via manual configuration.

A network operator configures the DNS Server with a well-known host name that corresponds to each management cluster (e.g., configsrv.sharedID.com or configsrv.unitID.mil). The IP address that corresponds to this host name is an anycast IP address that will serve as the shared IP address for all nodes in the management cluster that have the capability to serve as a configuration file repository.

Preferably, the UDP protocol packet format is used for configuration discovery request, response and notification. A sender is the node 106 that transmits the packet. A receiver is the node 106 that receives the packet sent by the sender. The packet contains the message type (3-bits), a sequence number (5-bits) and a payload. The message types are REQUEST (0x01), RESPONSE (0x02), or NOTIFICATION (0x03). The sequence number is a random number for peer nodes to correlate REQUEST and RESPONSE packets or to identify different NOTIFICATION messages from the same sender. The payload content is based on the message type. For a REQUEST message, the source address identifies the sender of the packet and the destination address is the management cluster anycast address. The payload contains the full configuration identifier 140 of the sender. A node that receives the request will respond by sending a RESPONSE message. The source address identifies the sender of the message, the destination address identifies the sender of the REQUEST message, and the sequence number is identical to the sequence number in the REQUEST message. The payload contains the configuration file version identifier and the path to retrieve the configuration file. The receiver of the RESPONSE message can then initiate a configuration file transfer. For a NOTIFICATION message, the payload contains the version identifier.

Attention now turns to a more detailed description of the embodiments of the autonomous management cluster formation and configuration discovery.

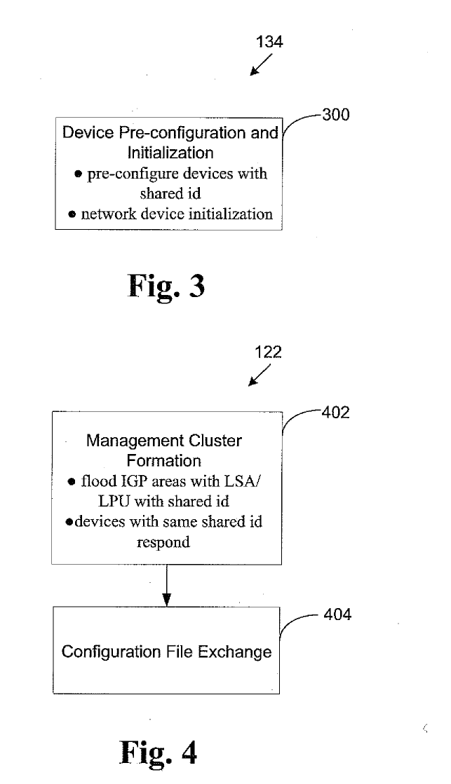

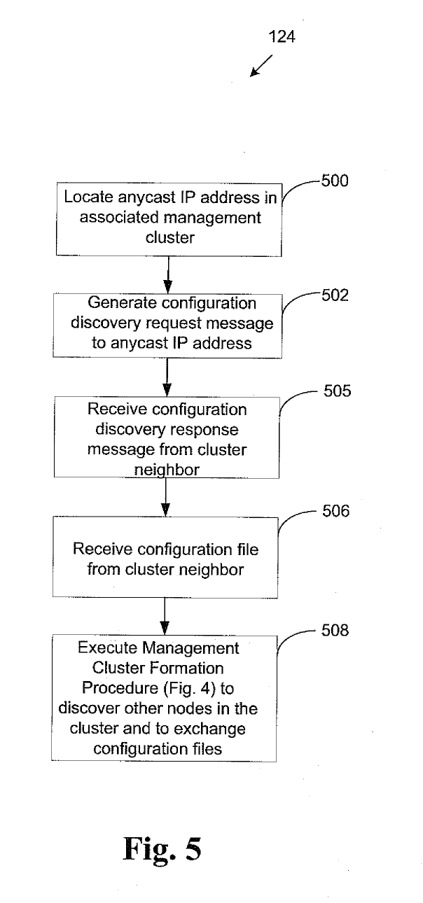

The configuration files 128 are initially created during a network planning stage. In a first embodiment, the initial configuration file 128 is created through an out-of-band configuration file download or through manual configuration via a Command Line Interface (CLI) on the node. The nodes in the same management cluster 110 will discover other nodes within the same cluster and replicate their configuration files, as shown in FIG. 4, thereby forming a distributed network configuration repository 128.

In the second embodiment, the configuration for each node is created using an existing network configuration generation tool (e.g., Cisco Configuration Assistant) and stored in a configuration file. Each configuration file 128 is assigned a corresponding full configuration identifier 140 and a configuration file version identifier 132. Configuration files 128 which belong to the same management cluster 110 will be pre-deployed to one or more nodes. Nodes 106 with the pre-deployed configuration will be initialized with their own configuration file 128. Other nodes 106 in the management cluster 110 will utilize a configuration discovery procedure 124, as shown in FIG. 5, to obtain their configuration file 128. In addition, the nodes in the same management cluster will also discover other nodes within the same cluster and replicate their configuration files, as shown in FIG. 4.

Turning to FIG. 3, a device is pre-configured with a full configuration identifier 140 (step 300). The full configuration identifier 140 is a concatenation of a configuration identifier and a shared identifier. The configuration identifier 140 is unique to the device and the shared identifier is one that is common with other nodes 106 in the same management cluster 110.

In a tactical environment, the full configuration identifier 140 uniquely identifies a node within a deployment. For example, a full configuration identifier 140 can represent an Army chain of command. Referring to FIG. 2, node 106a can be a network element that serves the Third Brigade of the 101st Airborne Division. The full configuration identifier 140 would be represented as “node106a3Brigade.101AirborneDivision”. Of this full configuration identifier 140, “3Brigade.101AirborneDivision” is the shared identifier for the brigade, while “node 106a” is the unique configuration identifier for the network element. In other cases, the device serial number can be used as the configuration identifier. In either case, the full configuration identifier 140 can be stored in a memory 118 in the device during the manufacturing process of the device or during the device's initialization or pre-configuration stage.

Turning back to FIG. 3, when the device is initially booted, it may be provided with an IP address through communication exchanges with a DHCP server (step 300) or via manual configuration. Nodes 106 store the IP address along with other configuration parameters (such as routing protocols, QoS policy etc.) in their configuration file 128.

Referring to FIG. 4, there is shown steps used in the managed cluster formation procedure 122 for the case where the initial configuration file 128 is created through an out-of-band configuration file download or through manual configuration via a Command Line Interface (CLI) on an initial set of one or more nodes.

Once the network is up and running, the management clusters begin to form autonomously (step 402). Within OSPF routing, a link state advertisement (LSA) is flooded from the initial set of node(s) to the other nodes in the IGP area. The LSA is used to communicate with other nodes 106 in the same IGP area. In particular, the opaque LSA option can be used to broadcast to the other nodes 106. The opaque LSA option allows an application-specific field to be added to the standard LSA header. This application-specific field can include the shared identifier of the node 106. The LSA is used to communicate the link state of the other nodes 106 in the IGP area and in particular, to advertise the shared identifier of the other nodes 106 (step 402). A more detailed description of the OSPF Opaque LSA Option can be found in RFC 5250, entitled “The OSPF Opaque LSA Option”, dated July 2008.

The flooding scope of the Opaque LSA can be set to either Link-state type-10 denoting an area-local scope that is not flooded beyond the borders of the associated area, or Link-state type-11 that denotes that the LSA is flooded throughout the IGP area depending on the size and scale of the deployment. The Opaque type of the Opaque LSA can use any values between 128-255 (defined for private use by RFC 5250). Note that all nodes in the deployment must use the same Opaque type value. The full configuration identifier 140 and the configuration file version identifier 132 are carried in the Opaque Information field of the Opaque LSA and padded to a 32 bit alignment. The size of the full configuration identifiers 140 and configuration file version identifier 132 is dependent on the deployment.

Alternatively, within IS-IS routing, a link state protocol data unit (LSP) can be used to communicate with other nodes 106 in the same IGP area. The LSP can be used to inform all the other nodes 106 in the IGP area with the node's link state information (e.g., router IP address, shared identifier, etc.) (step 402).

Each node 106 that receives the LSA or LSP, checks the shared identifier in the received communication. Tithe receiving node 106 has the same shared identifier, the receiving node responds to the node that transmitted the LSA or LSP with a response acknowledging receipt of the communication including an indication that it shares the same shared identifier (step 402). Those nodes responding with the same shared identifier are autonomously forming a management cluster 110 (step 402).

Each node that recognizes the same shared identifier in a received LSA/LSP transfers their configuration file 128 to every other node having the same shared identifier (step 404). This will be each node that transmitted a response to the LSA/LSP that has the same shared identifier. A version control mechanism is used to associate a configuration file version identifier 132 with the file, such as a local timestamp or monotonically increasing numeric value. The version identifier 132 is stored with the configuration file 128. Alternatively, each configuration file 128 in the cluster can be associated with the same version identifier 132.

From the LSA information, a node is able to know the configuration file version identifier 132 within the same management cluster 110. Therefore, a node can know if it is missing the current configuration file 128 or if it has a newer version of another node's configuration file 128. In the former case, the node will initiate a file transfer request to obtain a replication of the peer configuration file 128 as backup. In the later case, the node can send a NOTIFICATION to inform the other nodes of an available new configuration file 128. (Collectively, step 404).

Additionally, during the LSA exchange, a receiving node can learn of the configuration file version identifier 132 of a sending node in the same management cluster 110. Assume that node A sends an LSA received by node B within the same management cluster 110. The receiving node B compares the configuration file version identifier 132 in node A's LSA with the version number in its own configuration file repository for node A. If node B has a later (e.g., higher configuration file version number or later timestamp) version of node A's configuration file than that advertised by node A via the LSA, node B will send a NOTIFICATION message to node A to indicate the availability of a newer version. This mechanism can be used to disseminate configuration changes and updates to all nodes in the management cluster 110 by simply updating a single node in the management cluster with the relevant changes. (Collectively, step 404).

It should be noted that the communications between the nodes 106 can be secure communications using cryptographic keys and the like. The transmission of configuration files 128 can be secured using existing protocols, including but not limited to FTP-SSL, secure FTP, SCP, etc. The keys or certificates required for the secure exchange needs to be pre-deployed on the nodes 106.

FIG. 5 depicts the steps used in the configuration discovery procedure 124 by a network element to discover or recover its configuration file 128. In this scenario, a network element can join an existing management cluster 110 or a network element can be replacing a lost, destroyed, or corrupted configuration file 128. In either of these situations, the configuration discovery procedure 124 is executed to discover or recover the configuration file 128. The network element boots up with minimal network configuration information, such as the full configuration identifier which was stored in a memory and an initial IP address. The initial IP address can be obtained by means of the DHCP protocol or via manual configuration (as described previously above).

Referring to FIG. 5, the network element locates the anycast EP address associated with all the nodes in its management cluster 110 (step 500). Anycasting is a service which locates a host that supports a particular service which is the best or closest to the destination. (A more detailed discussion of IP anycasting can be found in RFC 1546, entitled, “Host Anycasting Service”, dated November 1993). In step 500, the network element can retrieve the anycast IP address from a DNS server by using a well-known DNS name (e.g., configsrv.sharedID.com or configsrv.unitID.mil) which may be derived from the shared identifier. Alternatively, the anycast IP address can already be known to the network element. All nodes in the management cluster 110 have the same anycast IP address.

Once the anycast IP address is obtained, the network element generates a REQUEST message to this anycast IP address (step 502). The closest neighboring network element having the same anycast IP address responds to the request by transmitting a RESPONSE message along with its IP address to the new network element (step 504).

Next, there is an exchange between the network element and the closest network element, where the network element retrieves the latest version of its configuration file 128 from the closest network element (step 506). The configuration file 128 is then stored in the network element's memory 114 and used in the operation the network element (step 506).

Once the network element obtains the current version of its configuration file, it then needs to participate with the other network elements in the cluster to exchange configuration files. This is accomplished by the network elements executing the steps used in the management cluster autonomous formation procedure 122, as shown in FIG. 4 (step 508). Thereafter, the network element is in sync with the other network elements in the cluster.

The embodiments described herein pertain to a distributed and fault tolerant technology where network elements within a management cluster store each other's configuration files. In this manner, a lost, corrupt, or destroyed configuration file can be readily replaced with minimal expense. In addition configuration changes can be disseminated to all the nodes within the management cluster by communicating them to one or more nodes within the management cluster. Other nodes within the management cluster can then discover the presence of updated configuration files and retrieve their configuration changes by communicating locally within the cluster. Such mechanisms can be vital in a MANET environment where all nodes may be not be reachable at a certain time.

The technology described herein does not require additional resources, such as dedicated configuration servers, to implement hereby being a cost effective solution. In addition, it is robust since it relies on existing standard routing protocols and can work with legacy network elements.

The foregoing description, for purposes of explanation, has been described with reference to specific embodiments. However, the illustrative teachings above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

One skilled in the art can easily modify the teachings herein to address the scenario where a network element retrieves configuration information from outside of its management cluster, such as in the case of the first network element in a management cluster. In addition, one skilled in the art can modify the teachings herein so that a network element can be part of several management clusters.

What is claimed is:

1. A method for operating a network, comprising the steps of:
forming a management cluster having a plurality of network elements; and
for each network element, storing a configuration file associated with each network element in the management cluster.

2. The method of claim 1, further comprising the steps of
receiving a request to obtain a configuration file from a select network element; and
transmitting the requested configuration file to the select network element.

3. The method of claim 1, wherein a network element closest to the select network element transmits the configuration file.

4. The method of claim 1, wherein the network elements in the management cluster have a common shared identifier.

5. The method of claim 1, the forming step further comprising the steps of
configuring a network element with a shared identifier; and
discovering one or more network elements having the same shared identifier.

6. The method of claim 2, wherein the transmitting step further comprises the step of
affixing a version identifier to the configuration file; and
storing the version identifier.

7. An apparatus for operating within a network, comprising:
a first memory to store a shared identifier;
a second memory to store a plurality of configuration files, each configuration file associated with a select network element; and
a processor that
discovers network elements having a common shared identifier,
forms a management cluster with the network elements having the common shared identifier, and
stores a configuration file associated with each network element having the common shared identifier.

8. The apparatus of claim 7, wherein the processor
discovers network elements having a common shared identifier, and
obtains a configuration file from a closest network element having a common shared identifier.

9. The apparatus of claim 7, wherein the shared identifier is pre-configured prior to operation in the network.

10. The apparatus of claim 7, wherein the network is a distributed network using IP protocols.

11. The apparatus of claim 7, wherein the processor
uses a link state routing protocol to flood an IGP area with a shared identifier, and
receives responses from nodes with same shared identifier.

12. The apparatus of claim 8, wherein the processor
locates an anycast IP address associated with the management cluster,
generates a configuration discovery request to the anycast IP address,
receives a configuration discovery response from a closest network element, and
receives the configuration file from the closest network element.

13. A computer program product comprising a computer readable storage medium having instructions for:
storing a shared identifier and a configuration file;
discovering network elements having a same shared identifier; and
sending the configuration file to each network element in the management cluster.

14. The computer readable storage medium of claim 13 having further instructions for:
receiving configuration files from other network elements in the management cluster.

15. The computer readable storage medium of claim 13 having further instructions for:
receiving a request from a first network element in the management cluster for a first configuration file; and
transmitting the first configuration file to the first network element.
